(19) United States
(12) Patent Application Publication
(10) Pub. No.: US 2012/0250456 A1
(43) Pub. Date: Oct. 4, 2012

(54) SYSTEMS AND METHODS FOR ENERGY HARVESTING IN A GEOPHYSICAL SURVEY STREAMER

(75) Inventor: Stig Rune Lennart TENGHAMN, Katy, TX (US)

(73) Assignee: PGS Americas, Inc., Houston, TX (US)

(21) Appl. No.: 13/073,823

(22) Filed: Mar. 28, 2011

(51) Int. Cl. G01V 1/38; F03G 7/08

(52) U.S. Cl. 367/20; 290/1 R

(57) ABSTRACT

A disclosed geophysical survey system includes one or more streamers having sensors powered by at least one energy harvesting device that converts vibratory motion of the streamers into electrical power. The vibratory motion may originate from a number of sources including, e.g., vortex shedding, drag fluctuation, breathing waves, and various flow noise sources including turbulent boundary layers. To increase conversion efficiency, the device may be designed with an adjustable resonance frequency. The design of the streamer electronics may incorporate the energy harvesting power source in a variety of ways, so as to reduce the amount of wiring mass that would otherwise be required along the length of the streamer.

### CROSS-REFERENCE TO RELATED APPLICATIONS

The present application relates to co-pending U.S. application Ser. No. ______ (Atty Dkt PGS-10-35), titled “Systems and Methods for Wireless Communication in a Geophysical Survey Streamer” and filed by inventors William T. Rickert, Jr. and S. Rune Tenghanm on the same day as the present application.

### BACKGROUND

Scientists and engineers often employ geophysical surveys for exploration, archeological studies, and engineering projects. Geophysical surveys can provide information about underground structures, including formation boundaries, rock types, and the presence or absence of fluid reservoirs. Such information greatly aids searches for water, geothermal reservoirs, and mineral deposits such as hydrocarbons and ores. Oil companies in particular often invest in extensive seismic and electromagnetic surveys to select sites for exploratory oil wells.

Seismic and electromagnetic surveys can be performed on land or in water. Marine surveys usually employ sensors below the water's surface, e.g., in the form of long cables or “streamers” towed behind a ship, or cables resting on the ocean floor. A typical streamer includes sensors positioned at spaced intervals along its length. Several streamers are often positioned in parallel over a survey region.

For seismic surveys, an underwater seismic wave source, such as an air gun, produces pressure waves that travel through the water and into the underlying earth. When such waves encounter changes in acoustic impedance (e.g., at boundaries between strata), some of the wave energy is reflected. The seismic sensors in the streamer(s) detect the seismic reflections and produce output signals. The sensor output signals are recorded, and later interpreted to infer structure of, fluid content of, and/or composition of rock formations in the earth's subsurface.

Similarly, for electromagnetic surveys, a underwater electrodes generate current flows in the water and the subsurface formations. Such current flows cause voltage drops to build and decay across subsurface formations and interfaces, thereby producing electric fields that can be sensed by antennas or electrodes in an underwater streamer. The sensor output signals are recorded, and later interpreted to infer structure of, fluid content of, and/or composition of rock formations in the earth's subsurface.

Conventional marine geophysical survey streamers may include hundreds, or even thousands, of sensors that are concurrently recording and communicating high resolution digital data to the ship and drawing power from the ship as they operate. The wiring that is typically employed to provide power and support communication may become a limiting factor as attempts are made to provide ever-longer streamers with improved performance. Though the use of more wiring can be offset by increasing the diameter of the streamer cable (so as to maintain a neutral buoyancy), the increased diameter tends to cause increased drag, to cause streamers to occupy substantially more room on the ship, and to make handling more difficult.

### BRIEF DESCRIPTION OF THE DRAWINGS

A better understanding of the various disclosed system and method embodiments can be obtained when the following detailed description is considered in conjunction with the drawings, in which:

FIG. 1 is a side elevation view of an illustrative marine geophysical survey system;

FIG. 2 is a top plan view of the marine geophysical survey system of FIG. 1;

FIG. 3 is an illustrative graph of velocity versus frequency for a towed streamer;

FIG. 4 is a schematic of an illustrative resonance frequency tunable energy harvesting device;

FIG. 5 shows an illustrative energy harvesting module for a sensor node;

FIG. 6 shows an illustrative spring-mass system for a harvesting device;

FIG. 7 is a flow diagram of an illustrative energy harvesting method; and

FIG. 8 is a flow diagram for a control system for power monitoring and load sharing.

While the invention is susceptible to various modifications and alternative forms, specific embodiments are shown by way of example in the drawings and will herein be described in detail. It should be understood, however, that the drawings and detailed description are not intended to limit the disclosure, but on the contrary, the intention is to cover all modifications, equivalents and alternatives falling within the scope of the appended claims.

### DETAILED DESCRIPTION

The issues identified in the background are at least in part addressed by the disclosed systems and methods for energy harvesting in a geophysical survey streamer. At least one embodiment of a geophysical survey system includes one or more streamers having sensors, and at least one energy harvesting device that converts vibratory motion of the streamers into electrical power. As the streamer is towed through a body of water, it can experience vibratory motion from a number of sources including, e.g., vortex shedding, drag fluctuation, breathing waves, and various flow noise sources including turbulent boundary layers. The energy harvesting device can take various forms including a mass-spring system and a piezoelectric transducer. To increase conversion efficiency, the device may be designed with an adjustable resonance frequency. The design of the streamer electronics may incorporate the energy harvesting power source in a variety of ways, so as to reduce the amount of wiring mass that would otherwise be required along the length of the streamer.

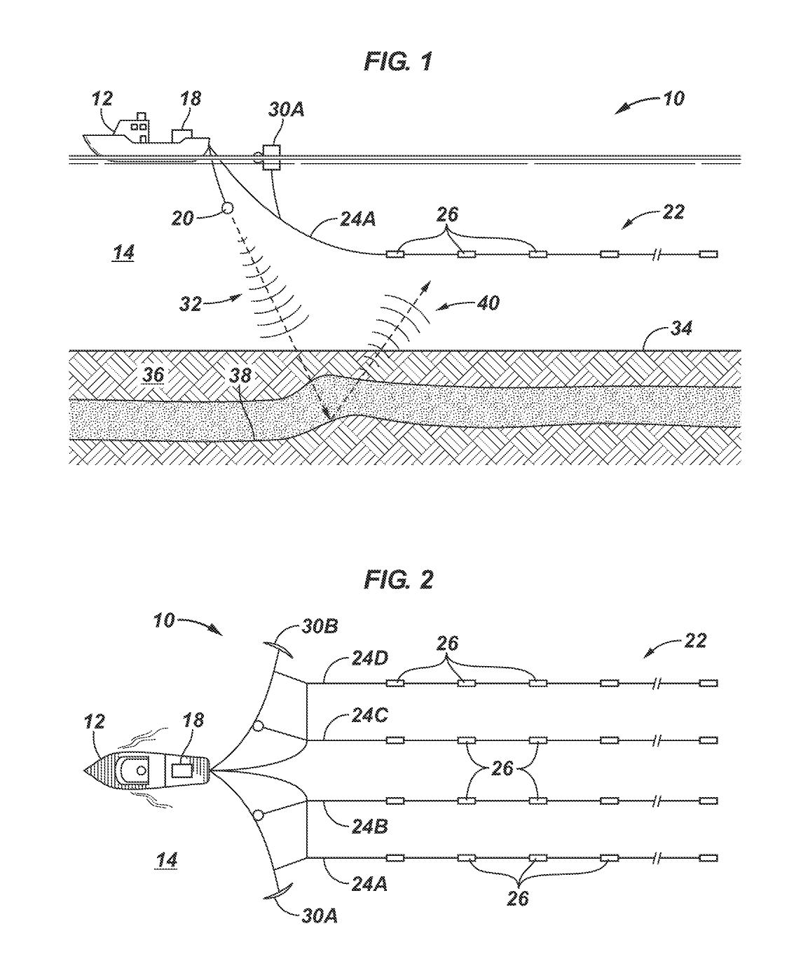

To assist the reader's understanding of the disclosed systems and methods, we first describe an environment for their use and operation. Accordingly, FIGS. 1 and 2 respectively show a side and top view of an illustrative marine geophysical survey system 10 performing a marine seismic survey. A survey vessel or ship 12 moves along the surface of a body of water 14, such as a lake or an ocean. The ship 12 tows an array of streamers 24A-24D, each streamer having multiple segments (aka sections) 26 connected end to end. Within each segment 26 are evenly spaced seismic sensors that detect and digitize seismic energy measurements and provide those measurements to a data recording and control system 18 aboard the ship 12. Survey system 10 further includes a seismic source 20, which may also be towed through the water 14 by the ship 12.

The streamers 24A-24D are towed via a harness that produces a desired arrangement of the streamers 24A-24D. The harness includes multiple interconnected cables, and a pair of controllable paravanes 30A and 30B connected to opposite sides of the harness. As the ship 12 tows the harness through the water 14, the paravanes 30A and 30B pull the sides of the harness in opposite directions, transverse to a direction of travel of the ship 12. Depth-controllers may also be provided along the length of the streamer to keep the streamer array largely horizontal.

The seismic source 20 produces acoustic waves 32 under the control of the data recording and control system 18, e.g., at regular intervals or at selected locations. The seismic source 20 may be or include, for example, an air gun, a vibratory source, or another form of seismic energy generator. The acoustic waves 32 travel through the water 14 and into a subsurface 36 below a bottom surface 34. When the acoustic waves 32 encounter changes in acoustic impedance (e.g., at boundaries between strata), some of the wave energy is reflected. In FIG. 1, ray 40 represents wave energy reflected in a particular direction from interface 35.

Sensor units of the sensor array 22, housed in the streamer sections 26 of the streamers 24A-24D, detect these seismic reflections and produce output signals. The output signals produced by the sensor units are recorded by the data recording and control system 18 aboard the ship 12. The recorded signals are later interpreted to infer structure of, fluid content of, and/or composition of rock formations in the subsurface 36.

There are often thousands of detectors in a given sensor array 22. A modular construction, e.g., with substantially identical and interchangeable sections 26, greatly simplifies handling, maintenance, and repair. If a problem develops with one of the streamer sections 26, the problematic streamer section 26 can be replaced by any other spare streamer section 26. The wiring that is typically employed to provide power and support communication may become a limiting factor as attempts are made to provide ever-longer streamers with improved performance. Accordingly, streamers 24 may be modified to employ energy harvesters so as to reduce wiring requirements.

Energy harvesting systems convert ambient energies such as vibration, temperature, light, etc. into usable electrical energy using energy conversion materials or structures to drive electronics, which often store the electrical energy in addition to performing other functions. See e.g., Chandrakasan, Amirtharajah, Goodman, Rabiner, “Trends in low power digital signal processing”, Proceedings of IEEE International Symposium on Circuits and Systems, 1998, 4:604-607. Three types of harvesting energy mechanisms are common: electromagnetic, electrostatic, and piezoelectric. Using the techniques taught in this disclosure, any of these three types can be employed to harvest energy from the vibrations of a towed seismic streamer.

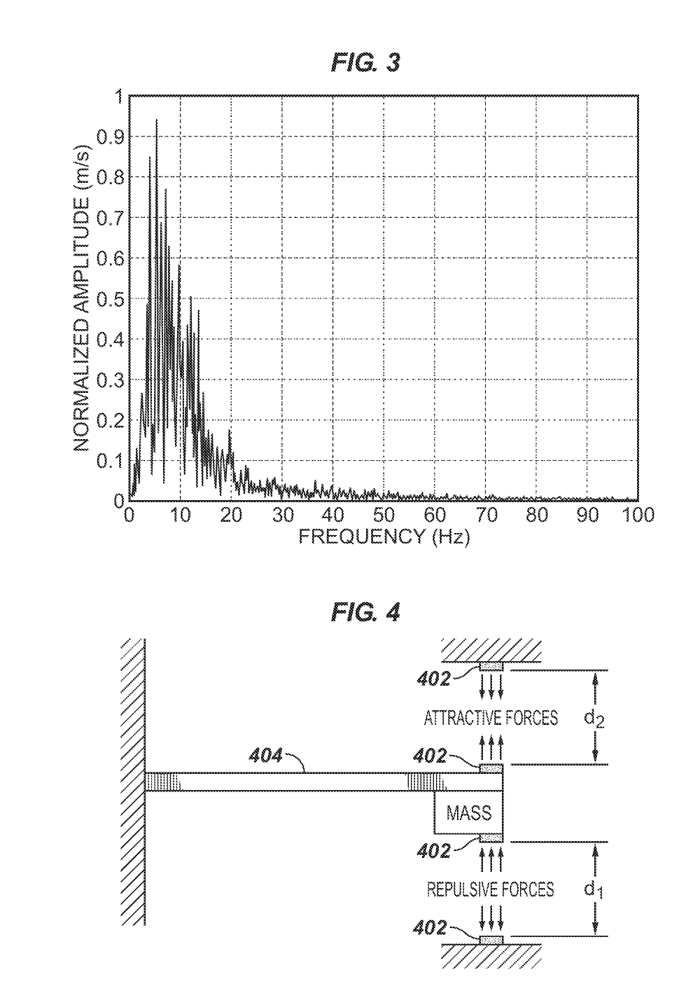

FIG. 3 is a graph of a streamer's vertical vibratory motion as a function of frequency at low tow speeds (3 to 6 knots). Most of the vibrational energy appears below 30 Hz, and is primarily associated with transverse waves moving along the streamer. The main vibration energy sources can be summarized as follows: tow cable strumming due to vortex shedding, fluctuating drag due to bird depth keeping forces, breathing waves induced by nearby vibration sources, turbulent boundary layer (TBL) induced vibrations and couplings, sea state induced vertical array motion, fluctuating diverter drag forces, and flow noise. The energy harvesting device is optimized for efficient energy conversion of these vibrations level and frequencies. Any vibration axis (vertical, crossline, or inline) can be used depending on which vibration directions are most favorable. Some embodiments may employ multi-axis harvesting configurations.

FIG. 4 illustrates the operating principles of a resonance frequency tunable energy harvesting device. The device embodiment illustrated by FIG. 4 includes a cantilever beam 404 positioned between two fixed surfaces so as to define a first gap d1 and a second gap d2. Four permanent magnets 402 are provided. Two of the magnets are arranged to repel each other across the first gap d1, and two are arranged to attract each other across a second gap d2. The mounting surface for the cantilever beam 404 is fixed on a clamp that can be vertically displaced using a screw-spring mechanism. With this mechanism the two gaps can be adjusted to alter the static magnetic force on the cantilever beam 404, thereby altering the effective stiffness of the beam and thus the resonance frequency of the beam as it vibrates. The stiffness change caused by reducing gap d1 is positive (thereby raising the resonance frequency) while the stiffness change caused by reducing gap d2 is negative (thereby lowering the resonance frequency). The cantilever beam can be constructed from a piezoelectric material to produce an oscillating voltage in response to vibration.

However, resonance frequency coupling may not be suitable for all environments, particularly those having irregular vibration patterns and large displacements. Such vibration characteristics are not expected for towed seismic streamers, but should that turn out to be the case, there do exist energy harvesting device embodiments which are designed to operate in a non-resonance mode or with a high degree of vibration damping to provide a broadband response. See, e.g. Mitcheson, Miao, Stark, Yeatman, Holmes, and Green, “MEMS electrostatic micropower generator for low frequency operation”, Sensors Actuators A, 115:523-9, 2004. Such designs offer the further advantages that frequency tuning is largely unnecessary and that they enable simultaneous conversion of energy at multiple frequencies.

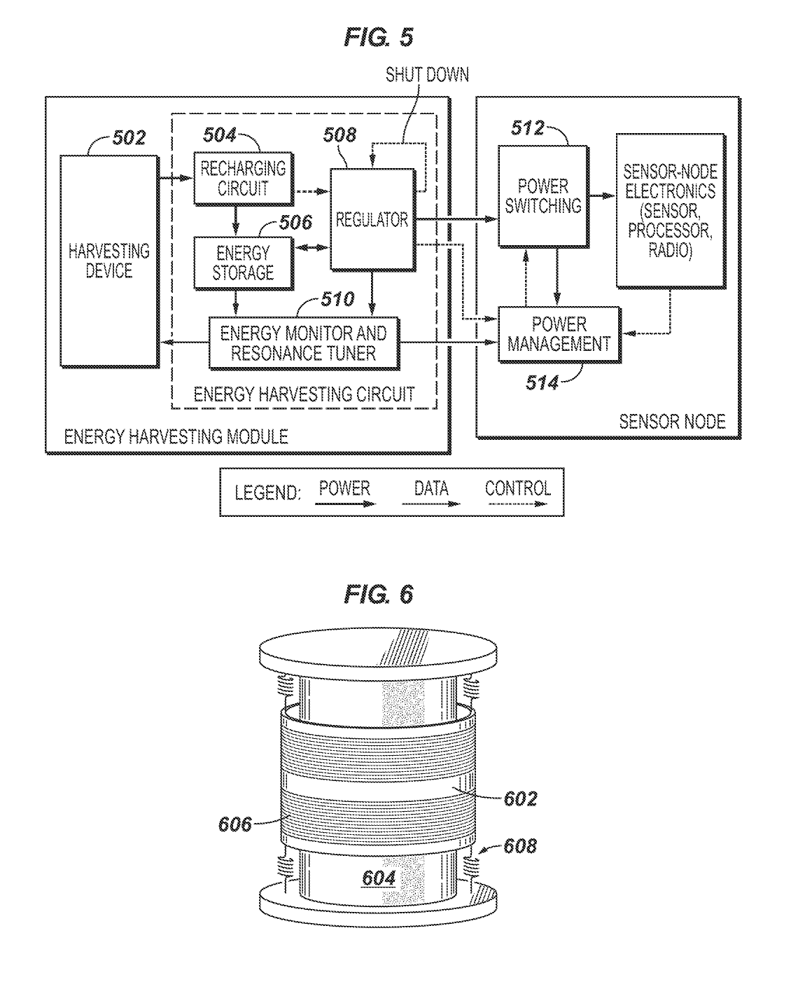

FIG. 5 shows an illustrative sensor node having an energy harvesting module. The module includes an energy harvesting device 502 that converts vibratory motion into electrical energy. Circuitry coupled to the harvesting device includes a recharging circuit 504 to convert alternating current from the harvesting device 502 into direct current, with suitable predefined limits on the output voltage and current. A regulator 508 stores excess energy in a storage device 506 such as a rechargeable battery or an ultracapacitor (also known as an electrochemical double layer capacitor or EDLC). As power is required by the sensor node, the regulator draws on the harvesting device 502 and the storage device 506 as necessary to supply it. Where insufficient power is available, the regulator can automatically shut down the output of the module so as to accumulate energy in the energy storage device 506. An energy monitor 510 collects status measurements from the energy storage device 506 and the regulator 508. These status measurements are used as the input to an algorithm that adapts the harvesting device's resonance frequency to optimize energy harvesting efficiency. Some illustrative algorithms analyze the power signal from the harvesting device to identify the strongest frequency component and tune the resonance frequency accordingly.

These status measurements are supplied to a power management circuit 514 in the sensor node which uses these measurements to determine the operating parameters of the sensor node electronics and thereby manage their power requirements. A power switching circuit 512 operates under control of the power management circuit 514 to deliver power to those portions of the sensor node electronics 511 that the power management circuit 514 selects based on the amount of stored energy and the rate at which additional energy is being harvested. With the built-in power management algorithm, the power management circuit 514 makes decision to either turn on or off the power switching 512 and control and optimize the functions of the regulator 508.

Alternative streamer embodiments, rather than having a single sensor node per energy harvesting module as shown in FIG. 5, may have sensor nodes arranged in groups and may further have hubs that each digitize measurement data from multiple sensor groups. Each such hub may be coupled to an energy harvesting module that powers the hub and its attached sensor groups.

FIG. 6 shows a contemplated embodiment of energy harvesting device 502. The illustrated embodiment employs a mass-spring system in which the mass is a hollow cylinder 602 mounted to a magnetized body 604 by one or more springs 608. The springs 608 enable the hollow cylinder 602 to oscillate in response to vibration of the system. As the hollow cylinder oscillates in the magnetic field provided by the magnetized body, an electrical current is induced in a wire coil 606 attached to the hollow cylinder. Very thin wires couple the coil 606 to circuitry that rectifies the current and uses it to charge a battery or capacitor. The mass of the cylinder and the stiffness of the springs are selected by the manufacturer to match the vibration frequencies that are expected to dominate.

Other contemplated harvesting device embodiments are MEMS (micro-electromechanical systems) devices having cantilever beams that oscillate in response to vibrations of the systems. The oscillations can be converted into electrical energy with piezoelectric materials, with electrostatic (i.e., capacitive) coupling, or with electromagnetic (i.e., inductive) coupling. Such devices can be obtained in the form of an integrated chip, enabling very compact implementations of energy harvesting modules. With such modules, it becomes possible to provide an energy harvesting device for each sensor, thereby enabling the creation of a self-contained sensor module. When the embodiment of FIG. 6 is employed, it is expected that each streamer segment would have at most ten energy harvesting modules to support the power requirements of the segment. For such implementations, it becomes important to manage the distribution of power among the supported electronic components as described further below.

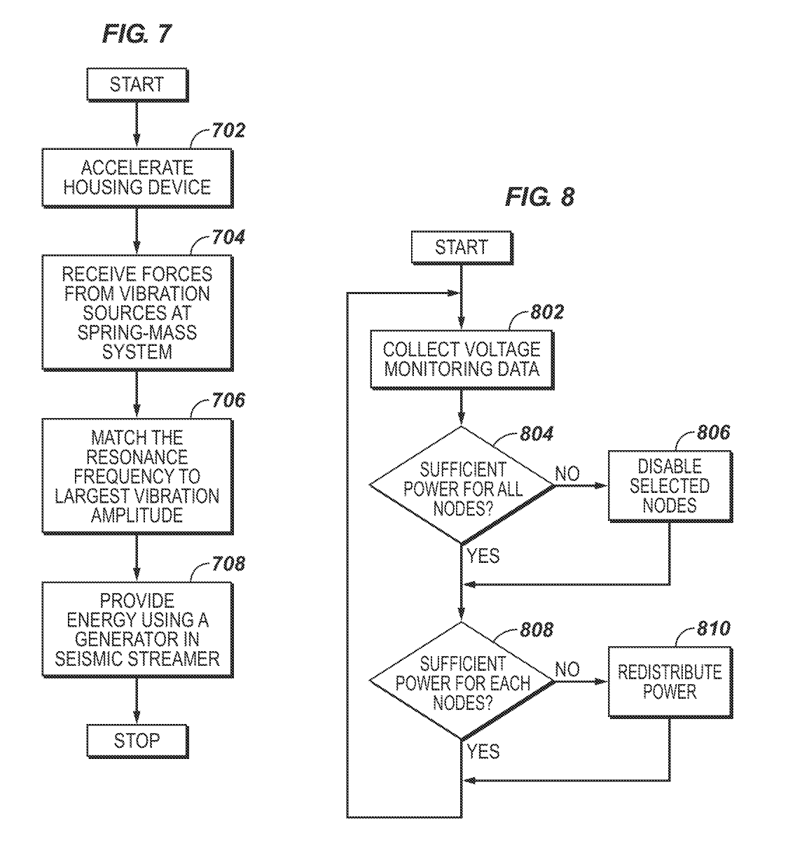

FIG. 7 is a flow diagram showing actions involved in an illustrative energy harvesting method for a seismic streamer. In block 702, the streamer is towed through the water, thereby causing vibrations that accelerate the housing of the energy harvesting module. These vibrations can be generated by various sources such as tow cable strumming due to vortex shedding, fluctuating drag due to bird depth keeping forces, breathing waves induced by nearby vibration sources, turbulent boundary layer (TBL) induced vibrations and couplings, sea state induced vertical array motion, fluctuating diverter drag forces, and other sources of flow noise. In block 704, the accelerations of the device housing produce oscillatory forces on the spring-mass system (or whatever form the mechanical-to-electrical energy converter takes), thereby driving the generation of electrical energy. In block 706, the energy harvester module optionally adapts the resonance frequency of the energy harvesting device to match the largest frequency component of the vibrations (e.g., block 510 in FIG. 5). Block 708 represents the energy harvester's provision of electrical power to other electronics in the seismic streamer.

FIG. 8 is a flow diagram of an illustrative method for power monitoring and load sharing. It can be implemented by a power management module 514 of an individual sensor node (FIG. 5), by a controller for one or more sensor groups, or by electronics higher in the survey system hierarchy up to and including the recording and control system 18 (FIGS. 1-2). In block 802, the controller collects data regarding the energy collection rate of the energy harvester(s). For the individual sensor node of FIG. 5, this data is provided by the energy monitor 510. In block 804, the controller determines whether there is sufficient power for all components or sensor nodes. If not, the controller selects which nodes should be enabled or disabled in block 806. In block 808 the controller determine whether each selected component or node is receiving sufficient power. If not, the controller redistributes the power among the components or nodes in block 810. This redistribution may include drawing power from storage to supplement transient shortfalls in harvester output, or arranging for some nodes to draw from different harvester modules. The controller repeats these actions to adapt the system to the available energy supply.

While specific system and method embodiments have been described above, it should be understood that they are illustrative and not intended to limit the disclosure or the claims to the specific embodiments described and illustrated. Numerous variations and modifications will become apparent to those skilled in the art once the above disclosure is fully appreciated. For example, the streamers may be electromagnetic survey streamers rather than seismic survey streamers. The streamers can receive power from the ship as well as from the energy harvesting modules, with the harvesters operating to reduce the required current draw from the ship. Some segments of a given streamer may employ harvesters (e.g., those segments farthest from the ship) while others do not. Other energy harvesting techniques (e.g., stretching electroactive polymers) can be employed besides those described herein. It is intended that the following claims be interpreted to embrace all such variations and modifications.

What is claimed is:

1. A geophysical survey system that comprises:
at least one geophysical survey streamer having multiple sensors; and
at least one energy harvesting device that converts vibratory motion of the at least one streamer into electrical power.

2. The system of claim 1, wherein said vibratory motion is caused by at least one of the following phenomena: vortex shedding, drag fluctuation, breathing waves, and turbulent boundary layer forces.

3. The system of claim 1, wherein the energy harvesting device employs a mass-spring system to perform said conversion.

4. The system of claim 1, wherein the energy harvesting device employs a piezoelectric transducer to perform said conversion.

5. The system of claim 1, wherein the energy harvesting device adapts its resonance frequency to match a largest component of the vibratory motion.

6. The system of claim 1, wherein the seismic sensor units are arranged in sensor groups, and wherein the streamer further includes multiple hubs with each hub digitizing data from multiple sensor groups.

7. The system of claim 6, wherein each hub receives power from a respective energy harvesting device.

8. The system of claim 1, wherein the at least one geophysical survey streamer includes multiple detachable segments, and wherein each segment includes at least one energy harvesting device.

9. A geophysical survey streamer that comprises:
a plurality of spaced apart sensor units; and
at least one energy harvesting device that converts motion of the streamer into electrical power for one or more of the sensors.

10. The streamer of claim 9, wherein said motion is caused by at least one of the following phenomena: vortex shedding, drag fluctuation, breathing waves, and turbulent boundary layer forces.

11. The streamer of claim 9, wherein the energy harvesting device employs a mass-spring system to perform said conversion.

12. The streamer of claim 9, wherein the energy harvesting device employs a piezoelectric transducer to perform said conversion.

13. The streamer of claim 9, wherein the energy harvesting device adapts its resonance frequency to the motion of the streamer.

14. The streamer of claim 9, wherein each of said sensor units receives power from a respective energy harvesting device.

15. The streamer of claim 9, wherein the sensor units are arranged in sensor groups, and wherein the streamer further includes multiple hubs with each hub digitizing data from multiple sensor groups.

16. The streamer of claim 15, wherein each hub receives power from a respective energy harvesting device.

17. A geophysical survey method that comprises:
towing at least one geophysical survey streamer in a body of water, thereby producing vibratory motion of the streamer;
converting at least some of the vibratory motion into electrical power for electronics in the streamer; and
using said electronics to provide a recording system with seismic data samples.

18. The method of claim 17, wherein said converting employs a mass-spring system.

19. The method of claim 17, wherein said converting employs a piezoelectric transducer.

20. The method of claim 17, wherein said converting includes adjusting a resonance frequency of an energy harvester to increase conversion efficiency.

21. The method of claim 17, wherein the electronics include seismic energy sensors.

22. The method of claim 17, wherein the electronics include electric field sensors for electromagnetic survey measurements.
